(19) United States
(12) Patent Application Publication
(10) Pub. No.: US 2017/0203514 A1
(43) Pub. Date: Jul. 20, 2017

(54) Methods and Apparatuses for Curing Three-Dimensional Printed Articles

(71) Applicant: The ExOne Company, North Huntingdon, PA (US)

(72) Inventors: Michael J. MCCOY, Murraysville, PA (US); Thomas LIZZI, Harmony, PA (US)

(21) Appl. No.: 15/326,508

(22) PCT Filed: Jul. 15, 2015
(86) PCT No.: PCT/US2015/040476

§ 371 Date: Jan. 16, 2017

Related U.S. Application Data
(60) Provisional application No. 62/025,598, filed on Jul. 17, 2014.

(51) Int. Cl. B29C 67/00; B33Y 30/00; B33Y 50/02; B33Y 10/00

(52) U.S. Cl. CPC B29C 67/0081; B29C 67/0088; B33Y 10/00; B33Y 30/00; B33Y 50/02

(57) ABSTRACT

Methods and apparatuses are disclosed for faster curing of three-dimensionally inkjet printed articles (88) having a curable binder. After the printing of the article (88) is completed, a gas flow is driven in the powder bed (90) that surrounds the article (88). The build box (54) which contains the powder bed (90) may include one or more gas-permeable features (14) in contact with the powder bed (90). The gas-permeable feature (14) may be in the form a plurality of gas-permeable disks (18) which are flush with the supporting surface (26) of the build box floor (12) and which are in fluid communication with the channels (28) of the bottom surface (30) of the build box floor (12). Curing apparatuses (50) are disclosed which have a cavity (68) for receiving the build box (54) and a gas propulsion device (74a) for driving a gas flow in the build box (54). Methods also include driving gas flow in the powder bed (90) by way of wands (230) and paddles (240).

### BACKGROUND

Field of the Invention

The present invention relates to methods and apparatuses for curing three-dimensionally printed articles.

Background of the Art

Three dimensional printing was developed in the 1990's at the Massachusetts Institute of Technology and is described in several United States patents, including the following United States patents: U.S. Pat. No. 5,490,882 to Sachs et al., U.S. Pat. No. 5,490,962 to Cima et al., U.S. Pat. No. 5,518,680 to Cima et al., U.S. Pat. No. 5,660,621 to Bredt et al., U.S. Pat. No. 5,775,402 to Sachs et al., U.S. Pat. No. 5,807,437 to Sachs et al., U.S. Pat. No. 5,814,161 to Sachs et al., U.S. Pat. No. 5,851,465 to Bredt, 5,869,170 to Cima et al., U.S. Pat. No. 5,940,674 to Sachs et al., U.S. Pat. No. 6,036,777 to Sachs et al., U.S. Pat. No. 6,070,973 to Sachs et al., U.S. Pat. No. 6,109,332 to Sachs et al., 6,112,804 to Sachs et al., U.S. Pat. No. 6,139,574 to Vacanti et al., U.S. Pat. No. 6,146,567 to Sachs et al., U.S. Pat. No. 6,176,874 to Vacanti et al., U.S. Pat. No. 6,197,575 to Griffith et al., U.S. Pat. No. 6,280,771 to Monkhouse et al., U.S. Pat. No. 6,354,361 to Sachs et al., U.S. Pat. No. 6,397,722 to Sachs et al., U.S. Pat. No. 6,454,811 to Sherwood et al., U.S. Pat. No. 6,471,992 to Yoo et al., U.S. Pat. No. 6,508,980 to Sachs et al., U.S. Pat. No. 6,514,518 to Monkhouse et al., U.S. Pat. No. 6,530,958 to Cima et al., U.S. Pat. No. 6,596,224 to Sachs et al., U.S. Pat. No. 6,629,559 to Sachs et al., U.S. Pat. No. 6,945,638 to Teung et al., U.S. Pat. No. 7,077,334 to Sachs et al., U.S. Pat. No. 7,250,134 to Sachs et al., U.S. Pat. No. 7,276,252 to Payumo et al., U.S. Pat. No. 7,300,668 to Pryce et al., U.S. Pat. No. 7,815,826 to Serdy et al., 7,820,201 to Pryce et al., U.S. Pat. No. 7,875,290 to Payumo et al., U.S. Pat. No. 7,931,914 to Pryce et al., U.S. Pat. No. 8,088,415 to Wang et al., U.S. Pat. No. 8,211,226 to Bredt et al., U.S. Pat. No. and 8,465,777 to Wang et al. In essence, three-dimensional printing involves the spreading of a layer of particulate material and then selectively jet-printing a fluid onto that layer to cause selected portions of the particulate layer to bind together. This sequence is repeated for additional layers until the desired article has been constructed. The material making up the particulate layer is often referred as the “build material” and the jetted fluid is often referred to as a “binder”, or in some cases, an “activator”; the term “binder” will be used herein to refer to all types of jetted fluids used in three-dimensional printing. Post-processing of the three-dimensionally printed article is often required in order to strengthen and/or densify the article.

Typically, one of the first steps of the post-processing is to cure the binder contained within the printed article to strengthen the printed article sufficiently so that it can be removed from the powder bed and handled. This curing step also includes the removal of at least some of the carrier portion of the binder by volatilization and removal of the volatilized binder from the powder bed. Conventionally, the curing step is conducted by placing the build box in an oven and applying heat to raise the temperature of the carrier portion of the binder to above its boiling point. This process takes many hours due to the effective thermal mass of the build box and its contents and the insulating effects of the build box and the powder bed. Another factor that slows the removal of the carrier is the resistance the powder bed presents to the flow of the volatized carrier as it permeates through the powder bed to the open top surface of the powder bed and into the oven chamber. Even when the build box was provided with gas-permeable disks in its floor surface to provide additional routes of escape for the volatized carrier, little or no effect on the curing time was noticed. Thus, there exists in the art a need for a shortening the curing step.

### SUMMARY OF THE INVENTION

The present invention provides methods and apparatuses for curing three-dimensionally printed articles faster than is conventionally accomplished. After the printing of the article is completed, a gas flow is driven in the powder bed that surrounds the article.

In accordance with some method embodiments of the present invention, an article is three-dimensionally printed by selectively inkjet depositing a curable binder onto a layer of powder (also sometimes referred to in the art as “particulate material” or “particles”) in the image of a first cross-sectional slice of the article and then repeating the selective deposition of the binder onto successive layers of the powder for each successive cross-sectional slice of the article until the entire article has been three-dimensionally printed and is surrounded by a powder bed. The powder bed is supported and confined by the floor and sides of a build box. The build box is adapted to be removable from the three-dimensional printing machine. The floor of the build box is vertically movable within the build box. In some embodiments of the present invention, at least one of the floor and the walls of the build box is at least partially gas-permeable. After the printing of the article has been completed, a flow of gas is made to pass through the powder bed to accelerate the curing of the printed article. In some method embodiments of the present invention, the direction of the gas flow is reversed from time to time to promote more uniform exposure of the various surfaces of the printed article to the gas flow and hence a more uniform and faster curing of the article.

In some method embodiments of the present invention, one or more wands or paddles are selectively operated within the powder bed to create a flow of gas to accelerate the curing. Such wands may be selectively inserted into the powder bed or they may be a feature of the build box. The gas flow may be the result of a pressure differential caused by the wand or paddle forcing or withdrawing gas from the powder bed or it may be the result of convective currents induced by a thermal gradient created by the wands in the gas the powder bed or a combination thereof.

In some method embodiments of the present invention, energy is applied to raise the temperature of the printed article to aid the curing of the printed article. In some such embodiments, at least some of the energy is applied as heat from the gas that flows through the powder bed. In some embodiments, the energy is applied directly to the powder bed and/or the printed articles within the powder bed, e.g. by the application of microwave energy, heating wands, cooling wands, etc.

The present invention also includes curing apparatuses which are adapted to operationally receive a build box having an at least partially gas-permeable floor and or walls. These apparatuses include a means for creating a pressure differential across the powder bed that is contained within a build box so as to create a draft through the powder bed, either locally or otherwise.

### BRIEF DESCRIPTION OF THE DRAWINGS

The criticality of the features and merits of the present invention will be better understood by reference to the attached drawings. It is to be understood, however, that the drawings are designed for the purpose of illustration only and not as a definition of the limits of the present invention.

FIG. 1 is shown a schematic perspective view of a three-dimensional printer which is suitable for use with some method embodiments of the present invention.

FIG. 2 is a schematic perspective view of a build box in accordance with some embodiments of the present invention.

FIG. 3 is a schematic top view of the build box of FIG. 2.

FIG. 4 is a schematic perspective view of the floor of the build box of FIG. 2.

FIG. 5A is a top planar view of a disk that is a portion of the build box of FIG. 2.

FIG. 5B is a side view of the disk of FIG. 5A.

FIG. 6 is a schematic perspective bottom view of the floor of FIG. 4.

FIG. 7 is schematic perspective view of a build box floor in accordance with some embodiments of the present invention.

FIG. 8 is a schematic perspective view of a build box in accordance with some embodiments of the present invention.

FIG. 9 is a schematic perspective view of a curing apparatus in accordance with some embodiments of the present invention.

FIG. 10 is a schematic vertical cross-sectional view of the curing apparatus of FIG. 9 taken along cutting plane 10-10.

FIG. 11 is a schematic vertical cross-sectional view of another curing apparatus in accordance with some embodiments of the present invention.

FIG. 12 is a schematic vertical cross-sectional view of another curing apparatus in accordance with some embodiments of the present invention.

FIG. 13 is a schematic vertical cross-sectional view of another curing apparatus in accordance with some embodiments of the present invention.

FIG. 14 is a schematic vertical cross-sectional view of another curing apparatus in accordance with some embodiments of the present invention.

FIG. 15 is a schematic perspective view of a wand in accordance with some embodiments of the present invention.

FIG. 16 is a schematic perspective view of a paddle in accordance with some embodiments of the present invention.

FIG. 17 is a schematic vertical cross-sectional view of a build box and wands in accordance with some embodiments of the present invention.

FIG. 18 is a schematic vertical cross-sectional view of a build box and wands in accordance with some embodiments of the present invention.

### DESCRIPTION OF PREFERRED EMBODIMENTS

In this section, some preferred embodiments of the present invention are described in detail sufficient for one skilled in the art to practice the present invention without undue experimentation. It is to be understood, however, that the fact that a limited number of preferred embodiments are described herein does not in any way limit the scope of the present invention as set forth in the claims. It is to be understood that whenever a range of values is described herein or in the claims that the range includes the end points and every point therebetween as if each and every such point had been expressly described. Unless otherwise stated, the word “about” as used herein and in the claims is to be construed as meaning the normal measuring and/or fabrication limitations related to the value which the word “about” modifies. Unless expressly stated otherwise, the term “embodiment” is used herein to mean an embodiment of the present invention.

It is to be understood that the word “curing” as used herein in connection with three-dimensional printed articles is to be construed as “causing the binder to change in a way that results in the strengthening of the printed article or articles sufficiently to permit the printed article or articles to be removed from the powder bed without physical damage.” In instances in which the binder includes a volatilizable solvent or carrier fluid, the curing will involve the removal of a portion or all of the solvent or carrier fluid from the printed article or articles. In some instances, the curing may include a chemical reaction in which one or more components of the binder is a reacting species. In some instances, the curing may involve polymerization and/or cross-linking of one or more components of the binder. In many instances, curing involves changing the temperature of the binder, most often by heating, but in some cases by cooling.

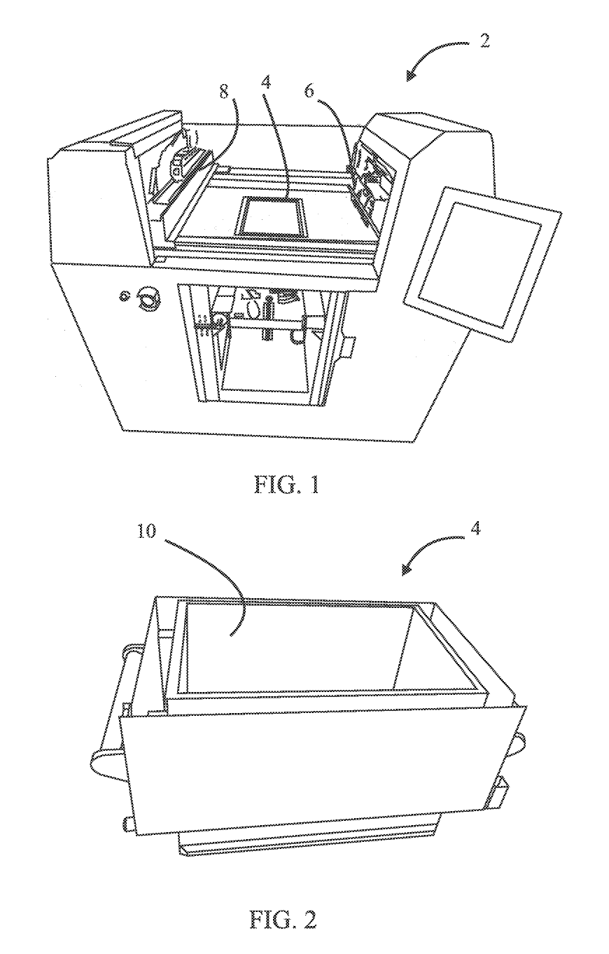

Referring to FIG. 1, there is shown a schematic perspective view of a three-dimensional printer 2 which is suitable for use with some of the method embodiments of the present invention. The printer 2 includes a removable build box 4 (only the top surfaces of which are visible in FIG. 1) having a vertically indexable floor, a powder layer depositing device 6, and a selectively positionable printing device 8. During the operation of the printer 2, after the powder layer depositing device 6 has deposited one or more layers, the printing device 8 imparts the image of a slice of the article or articles which are to be printed by selectively inkjet printing (also known as binder jetting) a binder onto the uppermost deposited powder layer. The floor of the build box 4 is indexed downward to receive each next layer deposited by the powder layer depositing device 6. The process of layer deposition and printing is continued until all of the desired article or articles have been printed.

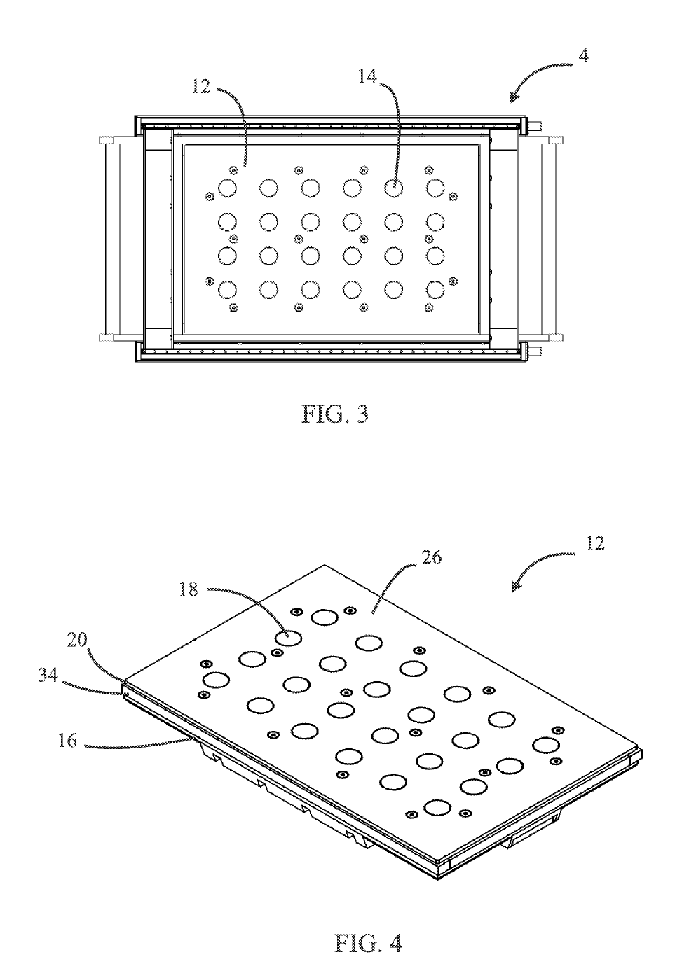

FIG. 2 shows a schematic perspective view of the build box 4 and FIG. 3 shows a schematic top view of the build box 4. The build box 4 has four vertical walls 10 and a gas-permeable floor 12. The floor 12 has selected areas, e.g. area 14, which are gas-permeable. More details of the floor 12 are shown in FIGS. 4-6.

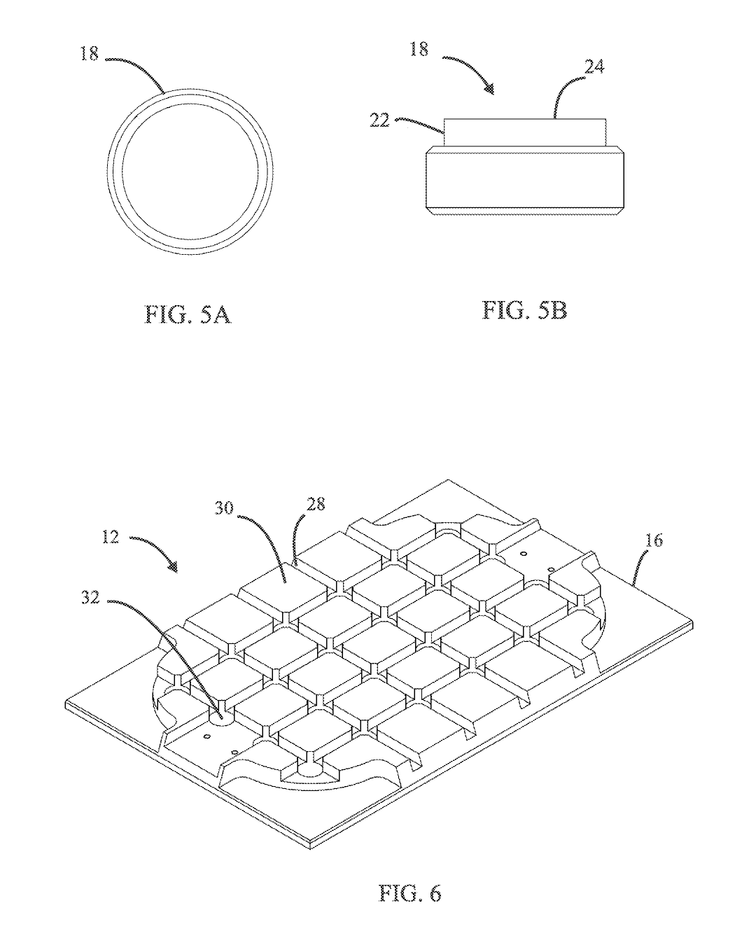

The floor 12 is shown apart from the rest of the build box 4 as a schematic perspective view drawing in FIG. 4. The floor 12 comprises a support plate 16, a plurality of gas-permeable disks 18 which are seated within open-bottom pockets on the top of side of the support plate 16, and a cover plate 20 which confines the disks 18 within the pockets. The disks 18 have interconnected porosity through which gas can flow through the disks 18 but through which the build powder cannot pass. FIG. 5A and 5B show, respectively, a top planar view and a side view of a disk 18 which is made from sintered stainless steel powder and has a relative density of about 60 percent. Note that the disk 18 has a raised top portion 22 which is adapted to extend through the cover plate 20 so that the top surface 24 of disk 18 is flush with the top surface 26 of the cover plate 20 (see FIG. 4) so as to obviate the need to apply powder layers to fill in the cavities between the top surface of the disk and the top plate surface that exists for prior art disks.

FIG. 6 shows a schematic perspective view of the bottom side of the floor 12, showing the support plate 16. The support plate 16 has a plurality of channels 28 dividing its bottom surface 30. The channels 28 intersect each other at the lower ends 32 of the open-bottom pockets in which the disks 18 are seated on the support plate's 16 top surface. The channels 28 extend to the outer periphery of the support plate 16 thus allowing gas to flow through the channels 28 and through the disks 18 even when the build box floor 12 is sitting upon its bottom surface 30. A thin layer of felt, e.g. the felt strip 34, or other flexible material may be placed between the outer edges of the floor 12 and the walls 10 of the build box 4 to discourage powder from getting trapped or flowing therebetween.

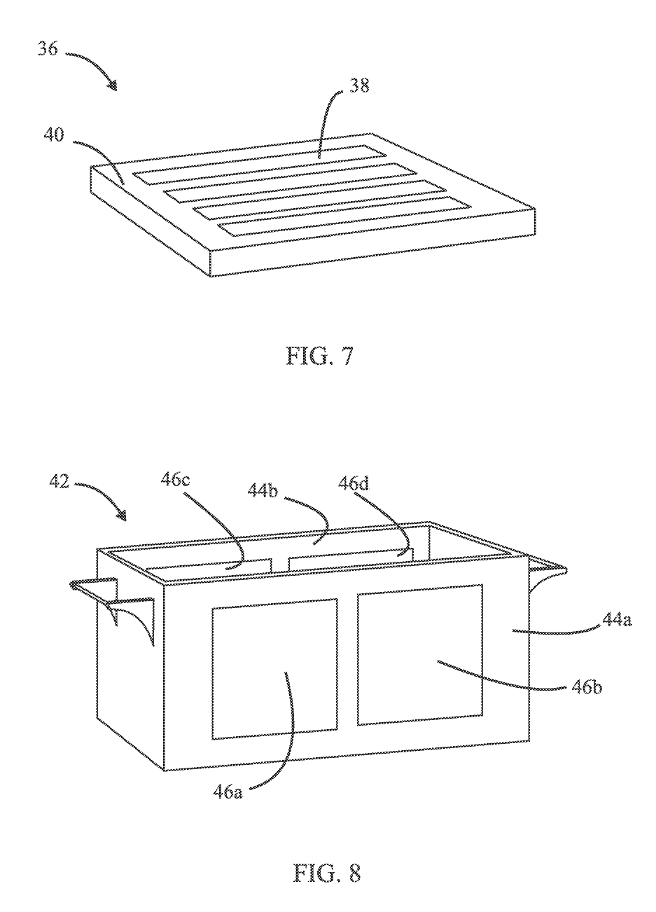

It is to be understood that many embodiments involve the use of build boxes of other designs which are able to support and laterally confine the build bed in which the printed article or printed articles reside and at least one of the sides and the floor of the build box is at least partly gas-permeable so that a gas flow may be maintained through the powder bed during the curing operation. In some embodiments, the build box floor is made entirely from a gas-permeable material (e.g. a sintered metal, a metal foam, a polymer, a composite material, etc.) having open porosity where both the top and bottom sides of the floor are featurelessly planar. In some embodiments, such as that depicted in FIG. 7, the floor's bottom side has channels which extend to its outer periphery. Yet another example is depicted in FIG. 7, wherein it is shown that the build box floor 36 has a plurality of gas-permeable plates 38 inset into recesses in a support plate 40. The plates 38 are kept in place by interference fits with the recesses in which they sit, though other means, e.g., a cover plate, fasteners (e.g. screws), adhesives, weldments, etc. may be used instead of or in addition to the interference fits to hold the plates 38 in place.

It is also to be understood that one or more of the walls of the build box may be at least partly gas-permeable. In such embodiments, it is preferably that opposing walls are gas-permeable so as to facilitate a cross-flow of gas through the powder bed. In some embodiments, all of the sidewalls are made gas-permeable so that a gas flow can be made first in one direction and then in a cross-direction to the first direction. In some embodiments, all or a selected portion or portions of the gas-permeable wall is made to be gas-permeable. For example, FIG. 8 shows a schematic perspective view of a build box 42 having gas-permeable sidewalls 44a, 44b. The sidewall 44a has gas-permeable panels 46a, 46b and the sidewall 44b has gas-permeable panels 46c, 46d.

In some embodiments, the build box floor is gas-permeable along with one or more of the build box walls. In these embodiments, the direction of gas flow can be changed from vertical to horizontal and from horizontal to vertical.

It is to be understood that although the build box floor is vertically indexible, it is preferable to have stops in the build box upon which the floor rests when it is in its lowest position. These stops must be kept out of way of the lifting devices which vertically indexes the floor during the printing operation. For example, the stops may located in the lower corners of the build box. The stops must be of sufficient strength and rigidity to support the floor and the powder bed once the support of lifting device of the printer is withdrawn.

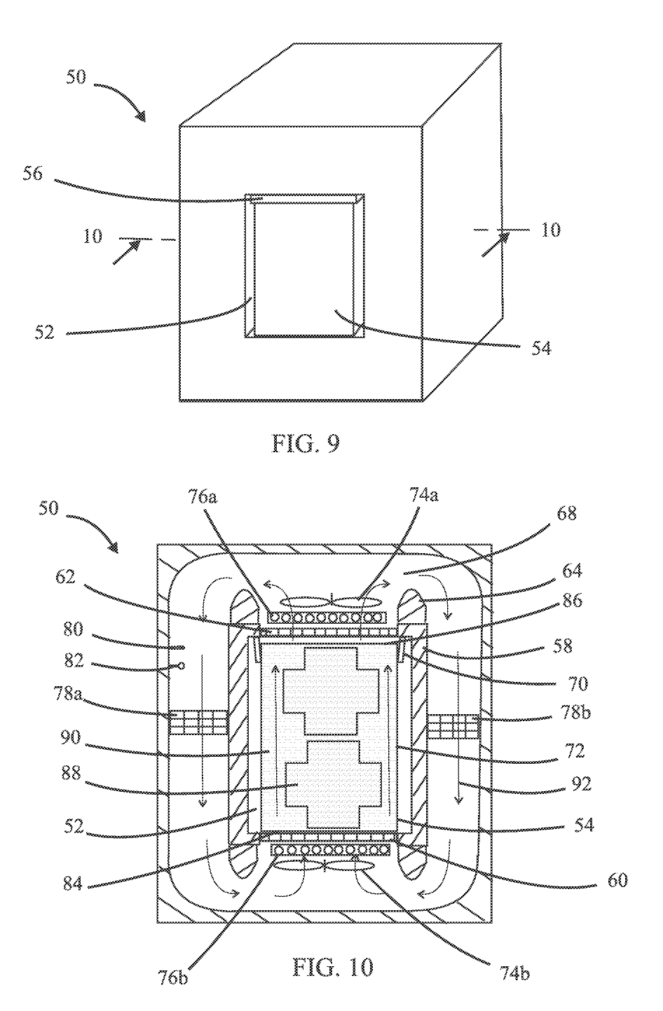

In some embodiments, after the desired article or articles have been printed, the build box is removed from the three-dimensional printer and subsequently placed into a curing apparatus which is adapted to receive the build box and to subject its powder bed to a gas flow. FIGS. 9 and 10 show an example of an embodiment of an exemplar curing apparatus. It is to be understood that the schematic drawings presented in these figures and other figures herein omit elements which are ancillary to the operation and control of those which are represented in the figures, e.g. control units and devices, motors, heating and cooling lines, wiring, supply lines, drainage lines, supports, pass-throughs, positioning devices, etc., which a person skilled in the art would understand to be implicitly present in the devices depicted. It is also to be understood that the depiction of a single device in a schematic drawing is meant to be understood as teaching a single or a plurality of devices performing the function attributed to the shown instance of the device.

It is noted that many embodiments include a “collection device.” That term is to be understood herein as meaning any device, e.g. a condenser, a filter, a molecular filter, etc. or combination of devices, which singly or as a combination is capable of removing some or all of a volatized portion of the binder from the gas that is being used in the curing of the binder. For example, where the curing of a binder involves evaporating a carrier liquid or solvent, the collection device may be a condenser that is operated to condense the vaporized carrier liquid or solvent from the process gas.

Referring to FIG. 9, there is shown a schematic perspective view of a curing apparatus 50. The curing apparatus 50 has a receiving cavity 52 into which a build box 54 has been placed. The receiving cavity 52 has an upper seal 56 to seal against the top of the build box 52. In some embodiments similar seals are placed at the floor and/or the sides of the cavity 52, but for ease of presentation, only the upper seal 56 is presented in FIG. 8. Such seals can take on various forms, e.g. a flap, a reversibly expandable accordion structure, an elastomer, etc. The purpose of such seals is to decrease or prevent gas flow that is being circulated through the curing apparatus into and through the build box from escaping into the surrounding atmosphere and to reduce or eliminate the entrainment of atmospheric gases into the curing apparatus. In some embodiments, closures are used to close off the ends of the receiving cavity in addition to or instead of the described seals.

Referring now to FIG. 10, there is shown a schematic vertical cross-sectional view taken along cutting plane 10-10 of FIG. showing the build box 54 within the receiving cavity 52 of the curing apparatus 50. The open-ended receiving cavity 52 is defined by walls 58, supporting grate 60 and upper grate 62. These elements, in combination with baffles 64 also define in part the internal cavity 68 of the curing apparatus 50. The seals 70 are supported by the walls 58 and functionally form a seal against the upper portions of the vertical sides 72 of the build box 54. Residing within the internal cavity 68 are upper and lower heat exchangers 74a, 74b, controllably reversible gas propulsion devices 76a, 76b, collection devices 78a, 78b, a temperature sensor 80, and a chemical sensor 82. The build box 54 also has a gas-permeable floor 84, and an open top 86 and contains printed articles 88 surrounded by a powder bed 90.

The use of the curing apparatus 50 in some method embodiments will now be described with reference to FIG. 10. In this instance, the three-dimensional printing was conducted in air and the binder used contained a polymer dissolved in a solvent and the polymer cures by the entanglement of polymer chains upon the evaporation of the solvent. After the printing of the printed articles 88 has been completed, the build box 54 is removed from the three-dimensional printing machine (not shown) and placed within the receiving cavity 52 of the curing apparatus 50. The build box 54 is supported by and is in fluid communication with the gas-permeable supporting grate 60. The seals 70 are made to contact the sides 72 of the build box 54 so that the open top 86 of the build box 54 is in fluid communication with the gas-permeable upper grate 62. The gas propulsion devices 74a, 74b (which may be fans, turbines, etc.) are controlled to create a pressure differential across the powder bed 90 and so cause a draft to pass through the powder bed 90 and through the internal cavity 68 of the curing apparatus 50 in the direction indicated by arrows 92. The upper and lower heat exchangers 76a, 76b, which may be electrical heating elements, fluid filled tubes, etc., are operated to heat the draft passing through or over them. Although the heating of the draft can be done in any desired fashion, preferably, the heating is done in a controlled manner so as to gradually change the temperature of the powder bed 90 and the printed articles 88 so as to minimize the stresses in the printed articles 88 which accompany the change of the temperature of the printed articles 88 and the evaporation of the solvent. A portion of or all of the volatilized solvent which is entrained within the draft may be removed from the draft and collected by the collection devices 78a, 78b, which may be condensers, molecular filters, etc. The temperature of the draft may be monitored and/or controlled (e.g. manually, by an electronic control unit, etc.) by use of the temperature sensor 80 and the amount of solvent remaining in the draft may be monitored and/or controlled (e.g. manually, by an electronic control unit, etc.) by use of the chemical sensor 82. The curing is continued until a predetermined condition is reached, e.g. a predetermined draft temperature, a predetermined amount of time at a predetermined draft temperature, a predetermined solvent concentration in the draft, etc.

In some embodiments, the heat exchangers and/or the collection devices are used to cool the draft and thereby the printed articles and the powder bed after the heating portion of the curing process has been completed. In some embodiments, the temperature of the printed articles and the powder bed are brought down to room temperature or to near room temperature before the build box is removed from the curing apparatus. In some embodiments, the build box is removed from the curing apparatus while the printed articles and the powder bed are at an elevated temperature.

In some embodiments, the curing involves cooling rather than heating the printed articles from the temperature at which they were when the build box was placed into the curing apparatus. In such cases, the heat exchangers are operated to cool the draft and thereby the printed articles and the powder bed.

In some method embodiments, the direction of the flow of the draft is reversed from time to time to promote a more uniform exposure of the various surfaces of the printed article or articles to the gas flow and hence a more uniform and faster curing of the printed article or articles. The direction change may be controlled by time, e.g., changed every so many minutes, or controlled by the reaching of certain temperatures, or controlled by the measured change in temperature, or controlled by the reaching of certain solvent concentrations in the draft, or controlled by the measured change in solvent concentration in the draft, or controlled by any combination of the foregoing.

It is within the scope of the present invention to control the imposed flow rate of the draft to any desirable magnitude and direction. The imposed flow rate is to be understood to be the flow rate that is caused by the operation of the gas propulsion devices of the curing apparatus and/or the wands and/or paddles which are used in the powder beds (wands and paddles are described below). Preferably, the upper limit of the imposed flow rate is the flow rate at which the powder bed becomes sufficiently fluidized that it is no longer able to perform its function of supporting the printed articles to prevent the printed articles from deforming due to the pull of gravity. It is to be understood that as the curing process progresses, the printed articles strengthen so that the upper limit of the imposed flow rate may be increased correspondingly without resulting in damage to the printed articles. It is also preferred that the magnitude of the imposed flow rate be kept below that which will entrain powder from the powder bed into the internal chamber of the curing apparatus; in embodiments wherein the curing apparatus includes a screen to prevent powder from entering the internal chamber or wherein a screen is used to cover the open top of the build box, it is preferred that the magnitude of the imposed flow rate be kept below that which will entrain powder from the powder bed to the point at which the entrained powder blocks the screen to significantly decrease the effective flow rate of the draft.

The present invention is not limited to use with printed articles in which the binder contains polymers, let alone polymers which strengthen by an entanglement mechanism as was used in the description of the embodiment with regard to FIG. 10. The present invention encompasses the use of all curable three-dimensional printable binders now known or later developed, including single part binders (i.e. binders which are administered as a single fluid even though that fluid may contain multiple component substances) and multipart binders (i.e. binders which are administered as more than a single fluid, e.g. as multiple fluids, as a combination of a pre-existing particle coating and a fluid, etc.). It is to be understood that the term fluid is to be construed as including liquids, gases, and flowable solids, plasmas, and combinations thereof.

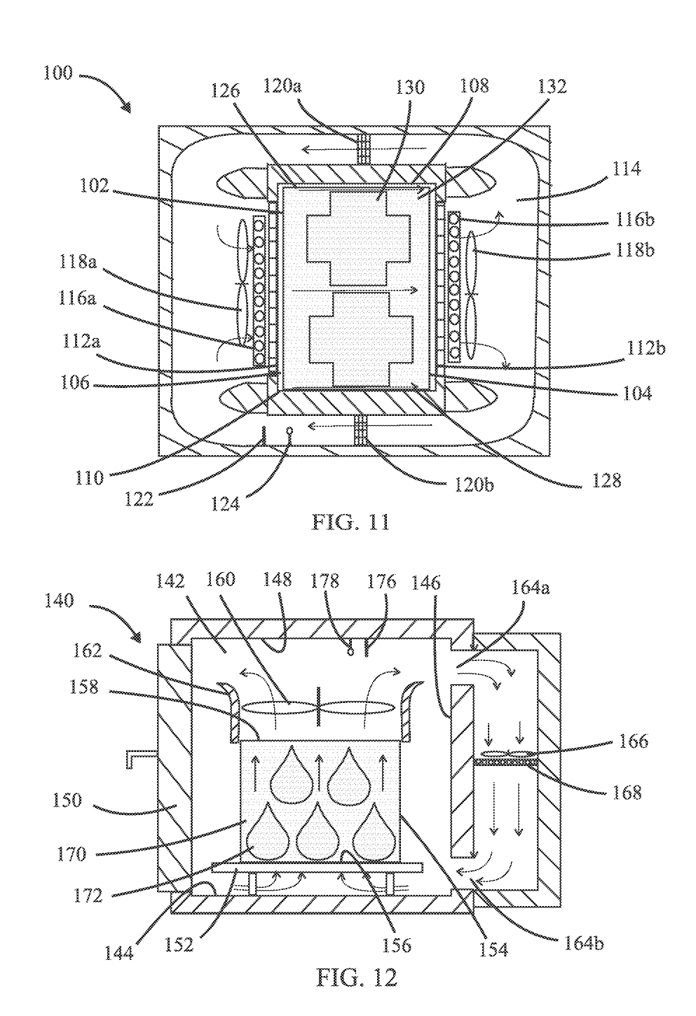

It is to be understood that the curing apparatus described with reference to FIGS. 9 and 10 is just an example of one of many embodiments of a curing apparatus. For example, FIG. 11 shows a schematic vertical cross-sectional view of another curing apparatus embodiment, i.e. curing apparatus 100. The curing apparatus 100 is configured to apply a reversible draft horizontally through a build box, e.g. build box 102, which has gas-permeable sidewalls, e.g. the sidewalls 104. The curing apparatus 100 has a receiving cavity 106 for receiving the build box 102. The open-ended receiving cavity 106 is defined by a top wall 108, a bottom surface 110, and two gas-permeable sides 112a, 112b. The bottom surface 110 of the receiving cavity 106 is preferably provided with some means (not shown), e.g. a low friction surface, rails, rollers, etc., for aiding in the insertion and withdrawal of the build box 102 into and out of the receiving cavity 102. The curing apparatus 100 also has an internal cavity 114. Residing within the internal cavity 114 are left and right heat exchangers 116a, 116b, controllably reversible gas propulsion devices 118a, 118b, collection devices 120a, 120b, temperature sensor 122, and chemical sensor 124. The build box 102 has an open top 126 and a gas-impermeable floor 128 and contains printed articles 130 surrounded by a powder bed 132.

Method embodiments which utilize the curing apparatus 100 are similar to those already described with regard to the curing apparatus 50, except that the gas flow is made to traverse horizontally through the build box 102, instead of vertically as in the curing apparatus 50.

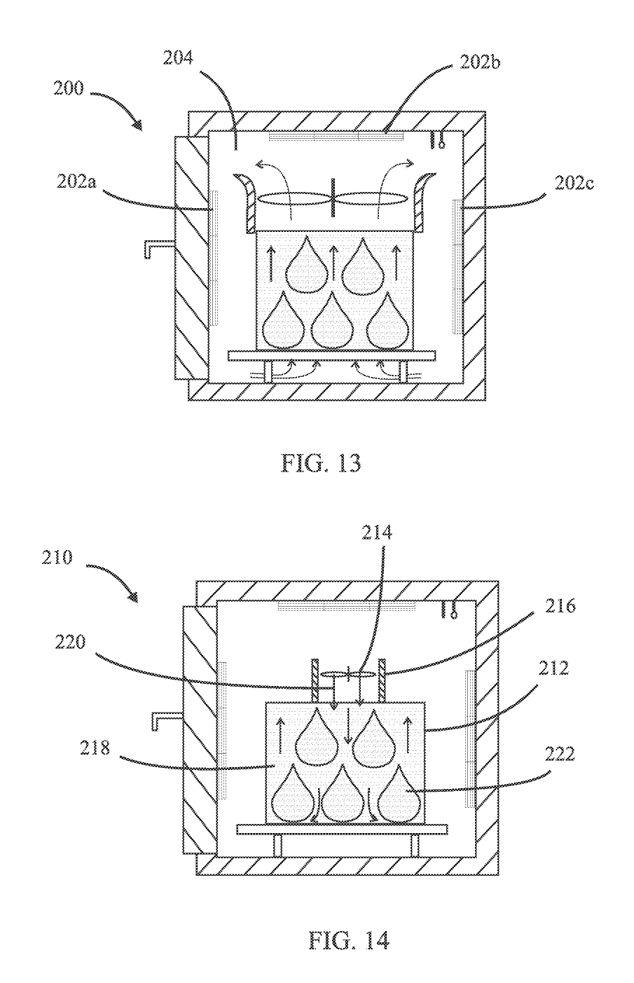

In some embodiments, the curing apparatus does not have a receiving cavity that is external to the curing apparatus, such as receiving cavities 52, 106 of the curing apparatuses 50, 100, respectively, but rather, internally receives the build box. FIG. 12 shows a schematic vertical cross-sectional view of such a curing apparatus, i.e. the curing apparatus 140. The curing apparatus 140 has an internal cavity 142 which is defined in part by the bottom surface 144, the back wall 146, the ceiling 148, and the door 150. The internal cavity 142 contains a plurality of rails (of which only one, rail 152, is shown) for supporting a build box 154 (which has a gas-permeable floor 156 and an open top 158) at a height sufficiently above the bottom surface 144 to permit a desirable amount of gas flow to engage the floor 156. (Note that when a build box which has a gas-permeable channeled floor as described previously herein is used, it may not be necessary to elevate the build box above the floor of the curing apparatus 140 as sufficient gas flow may be provided by way of the channeling.) The internal cavity 142 also contains a controllably reversible gas propulsion device 160 and baffles 162 for directing the gas flow. Although is within the scope of the present invention to modify the gas temperature within the internal cavity 142 through the use of a heat exchanger in conjunction with the gas propulsion device 160 similar to the ways depicted in the embodiments pictured in FIGS. 10 and 11 or through the use of heat exchangers attached to the walls, ceiling, door, and/or bottom surface of the internal cavity 142 (see the discussion below relating to FIG. 13), in the embodiment depicted in FIG. 12, the gas temperature in the internal cavity 142 is modified by way of the gas communicating with the internal cavity 142 through the ducts 164a, 164b which is heated and/or cooled by the auxiliary gas propulsion device 166 working in conjunction with the heat exchanger 168. Although the curing apparatus 140 has no collection device, it is within the scope of the present invention to provide one or more collection devices to apparatus embodiments which internally receive one or more build boxes. Such collection devices may be contained within the internal cavity 142 or external to the internal cavity 142 but in fluid communication with internal cavity 142, e.g. by way of ducting.

In method embodiments involving the use of the curing apparatus 140, the build box 154 is loaded onto the supporting rail 152 and the other supporting rails of the curing apparatus 140 through the door 150. The position of the baffles 162 and/or the gas propulsion device 160 may be adjusted relative to the build box 154 at this time to enhance the gas flow through the build box 154. After the door 150 has been closed, the gas propulsion device 160 is operated to drive, i.e. to draw or force, the ambient gas through the powder bed 170 and past the printed articles 172 which are contained within the build box 154. The auxiliary gas propulsion device 160 and the heat exchanger 168 may be adjusted at this time to start a heating and/or cooling regime in accordance with the desired curing process. In some embodiments, though, the auxiliary gas propulsion device 160 and the heat exchanger 168 are operated with the intention of maintaining the gas in the internal cavity 142 of the curing apparatus 140 at an essentially constant temperature, even during the loading of the build box 154. The curing apparatus 140 is equipped with a temperature sensor 176 and chemical sensor 178 and these can be used to control the gas temperature, the solvent concentration, etc. as described previously herein. The direction of the gas flow through the build box 154 may be changed from time to time. When the desired endpoint of the curing process has been reached, the build box 154 is removed from the curing apparatus 140 through the door 150.

Referring now to FIG. 13, there is shown a curing apparatus 200 according to another embodiment. The curing apparatus 200 is similar to the curing apparatus 140 that is shown in FIG. 12, but uses heat exchangers in the form of radiant heaters, e.g. heaters 202a, 202b, 202c, to control the temperature of the internal cavity 204 of the curing apparatus 200, instead of the temperature control system described above for curing apparatus 140. One or more of the heat exchangers may be placed behind a vented wall as is commonly done for convection heating ovens.

It is to be understood that the gas used within the curing apparatus in embodiments may be any desired processing gas or combination of process gases, e.g., air, nitrogen, argon, etc. In some instances during the curing process the gas may become laden to some undesirable extent with evaporated portions of the binder. It is within the scope of the present invention to inject a desired process gas into the curing apparatus and/or withdraw the processing gas from the curing apparatus during the curing process to maintain a desired composition to the processing gas which is being made to flow through the powder bed of the build box. The injection may be by way of inlets for pressurized gas or it may be by way of vents to draw gas in by a venturi effect. The withdrawal may be by way of vents or other openings in the curing apparatus to the surrounding atmosphere or conduits to a vacuum source.

In some embodiments, the walls of the curing apparatus are thermally insulated to minimize the heat exchange between the curing apparatus and the surrounding environment. When thermal insulation is employed, it is preferable that the type of thermal insulation be selected to avoid absorption of the volatiles arising from the binder during the curing into the thermal insulation or that a barrier interface material be provided to prevent the absorption of such volatiles by the thermal insulation. In some embodiments wherein the curing apparatus has a receiving cavity, e.g. receiving cavity 52 as shown in FIGS. 9 and 10, the walls of the receiving cavity, e.g. the walls 58 of the receiving cavity 52 shown in FIG. 10, are not thermally insulated as the heat exchange with these walls effectively will be with the build box itself and its contained powder bed and therefore will be beneficial to shortening the curing process time.

Although in the foregoing descriptions of the present invention have included build boxes which have a gas-permeable floor and/or walls, it is to be understood that the curing apparatuses of the present invention can be used, albeit less effectively, with build boxes which do not include these features. For example, with reference to the schematic vertical cross-sectional view of the curing apparatus 210 shown in FIG. 14 along with build box 212, none of the walls or the floor of the build box 212 is gas-permeable. The curing apparatus 210 is similar to the curing apparatus 200 shown in FIG. 13, but the baffles 216 have been moved inward to direct the gas flow at or from the center of the powder bed 218 and the gas propulsion device 214 is smaller than that of the curing apparatus 200. The gas propulsion device 214 may be operated to direct a gas stream into the powder bed 218 of the build box 212 (as indicated by the arrows 220) or to create a low pressure region above the powder bed 218, in either case preventing the volatiles coming off from the binder contained in printed articles 222 from establishing an equilibrium condition with the binder still remaining in the printed articles 222 and thereby hastening the removal of the volatiles and the shortening the curing process over what it would have been in static conditions.

In some embodiments one or more wands or paddles are inserted into the powder bed of the build box to hasten the curing of the binder. Such a wand or paddle may be a heat exchanger which heats or cools the powder bed by giving off or absorbing thermal energy. Alternatively or additionally, such a wand or a paddle may be a gas source or a vacuum source and cause a gas flow through the powder bed. In some embodiments, a gas source wand or paddle is used in proximity to one or more vacuum source paddles to control the direction of gas flow. Preferably, the temperature of the gas emitted by a wand or paddle is controlled so as to selectively heat or cool the powder bed and the printed articles therein. In some embodiments a plurality of wands and/or paddles are used in selected locations in the powder bed to selectively control the curing of the binder. In some embodiments, one or more wands and/or paddles are incorporated into walls and/or floor of the build box.

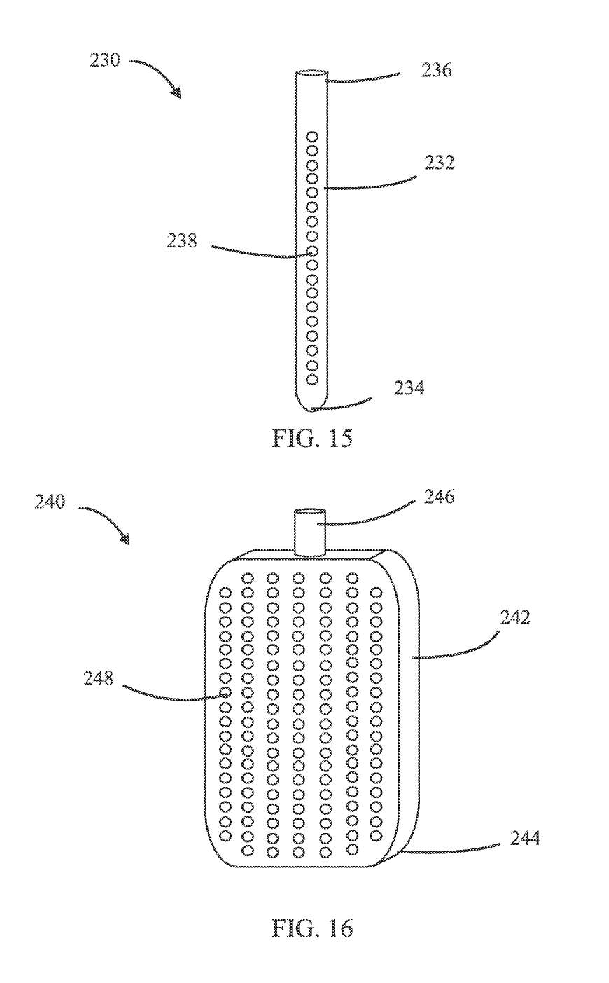

FIGS. 15 and 16 show, respectively, schematic perspective views of examples of a wand 230 and a paddle 240 that may be used with or as part of embodiments. Referring to FIG. 15, the wand 230 has a tubular body 232 which has a closed, rounded bottom end 234 to facilitate the wand 230 being inserted into place in a powder bed. The wand 230 has an open top end 236 which is adapted to be operationally connected to a gas source or a vacuum source. The wand 230 also has a plurality of holes, e.g. hole 238, which provide fluid communication between the interior of the wand 230 and the powder bed in which it is immersed. Referring now to FIG. 16, the paddle 240 has a broad body 242 which has a closed, rounded bottom end 244. The paddle 240 also has an open top end 246, which is adapted to be operationally connected to a gas source or a vacuum source, and a plurality of holes, e.g. hole 248, which provide fluid communication between the interior of the paddle 240 to the powder bed in which it is immersed.

It is to be understood that when a wand or paddle is used in an embodiment to accelerate curing, the location at which the wand or paddle is inserted into the powder bed must be carefully selected to avoid damaging the printed article or printed articles contained within the powder bed. Damage can result not only from direct impingement of the paddle or wand with a printed article but also by the way the paddle or wand is operated in proximity to a printed article if such operation creates detrimental stresses in the printed article due to excessive temperature change and/or volatilization rate differentials between different parts of the printed article.

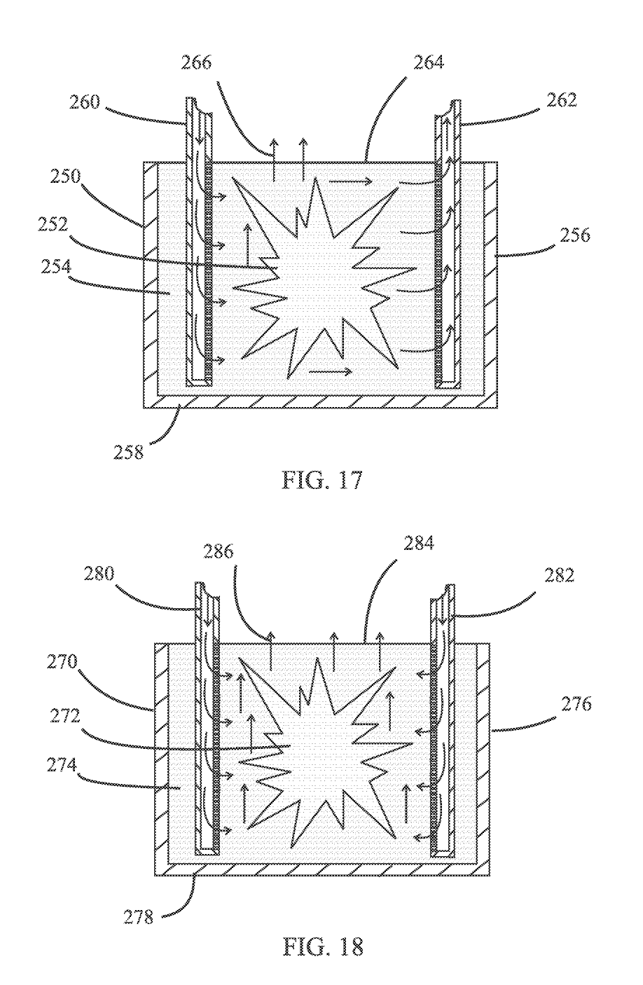

In some embodiments using a wand or paddle, no curing apparatus is used which receives the build box into an external or internal receiving cavity, although is to be understood that some embodiments using a wand or paddle utilize a curing apparatus which receives the build box into an external or receiving cavity. Referring to FIG. 17, there is shown a schematic vertical cross section of a build box 250 containing a printed article 252 within a powder bed 254. In the embodiment shown, the build box 250 has gas-impermeable side walls 256 and floor 258, although it is within the scope of the present invention to use wands and paddles with build boxes in which at least one of its sides and bottom is gas-permeable. A first wand 260 is inserted into the powder bed 254 on one side of printed article 252 and conveys a gas stream from a gas source (not shown) into the powder bed 254 via its plurality of holes. A second wand 262 is inserted on an opposite side of printed article 252 and conveys a gas stream from the powder bed 254 through its plurality of holes to a vacuum source (not shown). Note that some of the gas stream supplied by the first wand 260 may exit the open top surface 264 of the powder bed 254 as indicated by arrow 266.

Referring now to FIG. 18, there is shown a schematic vertical cross sectional view of a build box 270 containing a printed article 272 within a powder bed 274. The build box 270 has gas-impermeable side walls 276 and floor 278. A first wand 280 is inserted into the powder bed 274 on one side of printed article 272 and conveys a gas stream from a gas source (not shown) into the powder bed 274 via its plurality of holes. A second wand 282 is inserted on an opposite side of printed article 272 and also conveys a gas stream to the powder bed 274 via its plurality of holes from a gas source (not shown) which may be the same gas source that is in fluid communication with the first wand 280 or which may be a different gas source and even provide a different kind or pressure of gas. The gas stream supplied by the first and second wands 280, 282 exits the open top surface 284 of the powder bed 274 as indicated by arrow 286.

It is to be understood that although in the embodiments illustrated by the figures herein, e.g. gas propulsion devices 76a, 76b of FIG. 9, the gas propulsion devices were described as being controllably reversible, it is within the scope of the present invention that the gas propulsion devices be operable to cause flow in just one direction rather than be capable of reversible operation. It is also within the scope of the present invention to use a combination of gas propulsion devices across a powder bed which are adapted to direct flow in opposite directions and are operated so that one is off when the other is on so as to create a net flow across the powder bed. It is also within the scope of the present invention to use a combination of gas propulsion devices across a powder bed both of which have directed flow in the same direction. It is also to be understood that although the gas propulsion devices and their associated heat exchangers are shown as being located inside of the curing apparatuses, it is within the scope of the present invention that the gas propulsion devices and/or heat exchangers be located outside with of the curing apparatuses with ducts to carry the propelled gases to the desired locations on the build boxes to cause a draft within the powder beds.

It is also to be understood that the depiction of a single build box in the drawings does not limit the invention to embodiments employing single build boxes. Rather, the present invention includes embodiments which employ multiple build boxes. Also, in some embodiments which employ multiple build boxes, the build boxes are not of the same size or design, although their individual sizes and designs are adapted to be compatible with the embodiments in which they are used.

While only a few embodiments of the present invention have been shown and described, it will be obvious to those skilled in the art that many changes and modifications may be made thereunto without departing from the spirit and scope of the invention as described in the claims. All United States patents and patent applications, all foreign patents and patent applications, and all other documents identified herein are incorporated herein by reference as if set forth in full herein to the full extent permitted under the law.

What is claimed is:

1. A method for curing a three-dimensional inkjet printed article (88) comprising the steps of:
creating the article (88) within a powder bed (90) contained by a build box (54) by inkjet printing a binder onto successive layers of a powder; and
driving a gas flow through the powder bed (90).

2. The method of claim 1, wherein the build box (54) has a gas-permeable feature (84) contacting the powder bed (90).

3. The method of claim 2, further comprising the step of placing the build box (54) within a curing apparatus (50), the curing apparatus (50) being adapted to drive a gas flow through the gas-permeable feature (14).

4. The method of claim 3, wherein the curing apparatus (50) has a receiving cavity (68) being adapted to receive the build box (54) at least one of internally and externally.

5. The method of claim 1, further comprising the step of selectively controlling the temperature of the gas flow.

6. The method of claim 1, wherein the binder has a volatile component, the method further comprising the step of selectively controlling the amount of the volatile component in the gas flow.

7. The method of claim 1, wherein the step of driving a gas flow through the powder bed (90) includes forcing gas into the powder bed (90) through at least one of a wand (230) and a paddle (240).

8. The method of claim 1, wherein the step of forcing a gas flow through the powder bed (90) includes withdrawing gas from the powder bed (90) through at least one of a wand (230) and a paddle (240).

9. The method of claim 2, wherein the build box (54) includes a floor (12) and the floor (12) includes the gas-permeable feature (14).

10. The method of claim 9, wherein the floor (12) comprises a support surface (26), a bottom surface (30) having channels (28), and a plurality of gas-permeable disks (18), the gas-permeable disks (18) being flush with the support surface (26) and providing fluid communication between the powder bed (54) and the channels (28) of the bottom surface (30).

11. The method of claim 1, wherein the step of driving a gas flow through the powder bed (90) includes directing the gas flow in a direction, the method further comprising selectively changing the direction of the gas flow from time to time.

12. A build box (4) for a three-dimensional inkjet printer (2) comprising:
a plurality of walls (10) and a movable floor (12), the plurality of walls (10) and the floor (12) being adapted to cooperate to contain a powder bed (90), wherein at least one of the walls (10) and the floor (12) has a gas-permeable feature (14).

13. The build box (4) of claim 12, wherein the floor (12) comprises a support surface (26), a bottom surface (30) having channels (28), and a plurality of gas-permeable disks (18), the gas-permeable disks (18) being flush with the support surface (26) and providing fluid communication between the powder bed (90) and the channels (28) of the bottom surface (30).

14. A curing apparatus (50) for curing a three-dimensionally inkjet printed article (88) within a powder bed (90) contained by a build box (54), the curing apparatus (50) comprising:
a cavity (68) for receiving the build box (54); and
a gas propulsion device (74b) being adapted to drive a gas flow through the powder bed (90).

15. The curing apparatus (50) of claim 14, further comprising a heat exchanger (76b) being adapted to at least one of heat or cool the gas flow.

16. The curing apparatus (50) of claim 14, further comprising a collection device (78a) being adapted to remove from the gas flow at least a portion of a volatile component of a binder of the printed article (88).

17. The curing apparatus (50) of claim 14, wherein the gas propulsion device (74b) is adapted to controllably reverse the direction of the gas flow.

18. The curing apparatus (50) of claim 14, wherein the gas propulsion device (74b) is adapted to drive the gas flow through a gas-permeable feature (14) of a floor (12) of the build box (54).

19. The curing apparatus (50) of claim 14, wherein the gas propulsion device (118a) is adapted to drive the gas flow through a gas-permeable feature (46a) of a wall (112a) of the build box (102).

20. The curing apparatus (50) of claim 14, further comprising at least one of a temperature sensor (122) being adapted to monitor the temperature of the gas flow and a chemical sensor (124) being adapted to monitor the composition of the gas flow.
